(19) United States
(12) Patent Application Publication
(10) Pub. No.: US 2025/0244695 A1
(43) Pub. Date: Jul. 31, 2025

(54) DEVELOPING DEVICE, PROCESS CARTRIDGE, AND IMAGE FORMING APPARATUS

(71) Applicant: Kei SAITO, Tokyo (JP)

(72) Inventor: Kei SAITO, Tokyo (JP)

(73) Assignee: Ricoh Company, Ltd., Tokyo (JP)

(21) Appl. No.: 19/015,002

(22) Filed: Jan. 9, 2025

(30) Foreign Application Priority Data
Jan. 29, 2024 (JP) 2024-010761
Jun. 6, 2024 (JP) 2024-092338

(51) Int. Cl. G03G 15/08; G03G 21/18

(52) U.S. Cl. CPC G03G 15/0881; G03G 15/0808; G03G 15/0812; G03G 15/0893; G03G 21/1814

(57) ABSTRACT

A developing device includes a developing roller, a developer supply rotator, and a removable sheet-shaped member. The developing roller bears developer and develops a latent image on a surface of an image bearer. The developer supply rotator is disposed opposite the developing roller to rotate in a specified direction to supply the developer to the developing roller. The removable sheet-shaped member separates the developing roller and the developer supply rotator to form a developer pre-storage portion storing the developer in an inner space in which the developer supply rotator is disposed in the developing device. The sheet-shaped member intersects with a virtual line connecting a rotation center of the developing roller and a rotation center of the developer supply rotator at 90±10 degrees when viewed in a cross section orthogonal to a rotation shaft of the developing roller or the developer supply rotator.

### CROSS-REFERENCE TO RELATED APPLICATIONS

This patent application is based on and claims priority pursuant to 35 U.S.C. § 119(a) to Japanese Patent Application Nos. 2024-010761, filed on Jan. 29, 2024, and 2024-092338, filed on Jun. 6, 2024 in the Japan Patent Office, the entire disclosure of which is hereby incorporated by reference herein.

### BACKGROUND

### Technical Field

Embodiments of the present disclosure relate to a developing device to develop a latent image formed on an image bearer such as a photoconductor drum, a process cartridge including the developing device, and an image forming apparatus including the developing device.

### Related Art

In a developing device removably installed in an image forming apparatus such as a copier or a printer, a technique has been proposed in which a sheet-shaped member (sealing sheet) is removably installed to isolate, as a closed space, a space in which developer is stored so that the developer stored inside the developing device does not leak outside the developing device during transportation after the shipment from a factory.

### SUMMARY

In an embodiment of the present disclosure, a developing device detachably attachable to a body of an image forming apparatus and storing developer includes a developing roller, a developer supply rotator, and a removable sheet-shaped member. The developing roller bears the developer and develops a latent image on a surface of an image bearer. The developer supply rotator is disposed opposite the developing roller to rotate in a specified direction to supply the developer to the developing roller. The removable sheet-shaped member separates the developing roller and the developer supply rotator to form a developer pre-storage portion storing the developer in an inner space in which the developer supply rotator is disposed in the developing device. The sheet-shaped member intersects with a virtual line connecting a rotation center of the developing roller and a rotation center of the developer supply rotator at 90±10 degrees when viewed in a cross section orthogonal to a rotation shaft of the developing roller or the developer supply rotator.

In another embodiment of the present disclosure, a process cartridge removably attachable to a body of an image forming apparatus includes the developing device and an image bearer united with the developing device.

In still another embodiment of the present disclosure, an image forming apparatus includes the developing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a sectional view of an image forming device of the image forming apparatus of FIG. 1;

FIG. 3 is a sectional view of a developing device of the image forming device in FIG. 2 as viewed along a longitudinal direction;

FIG. 4 is an enlarged view of the developing device of FIG. 3;

FIG. 5 is a top view of a base of a lower developing case in a longitudinal direction;

FIG. 6 is an enlarged view of a developing device according to a comparative example;

FIG. 7 is a diagram illustrating a positional relation between a gear train and a sheet-shaped member in a developing device according to a first modification;

FIG. 8 is an enlarged view of an end in a longitudinal direction of a developing device according to a second modification;

FIG. 9 is an enlarged view of a developing device according to a third modification; and

FIG. 10 is an enlarged view of a developing device according to a fourth modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Like reference signs are assigned to like elements or components and descriptions of those elements or components may be simplified or omitted. As used herein, the singular forms “a,” “an,” and “the” are intended to include the plural forms as well, unless the context clearly indicates otherwise.

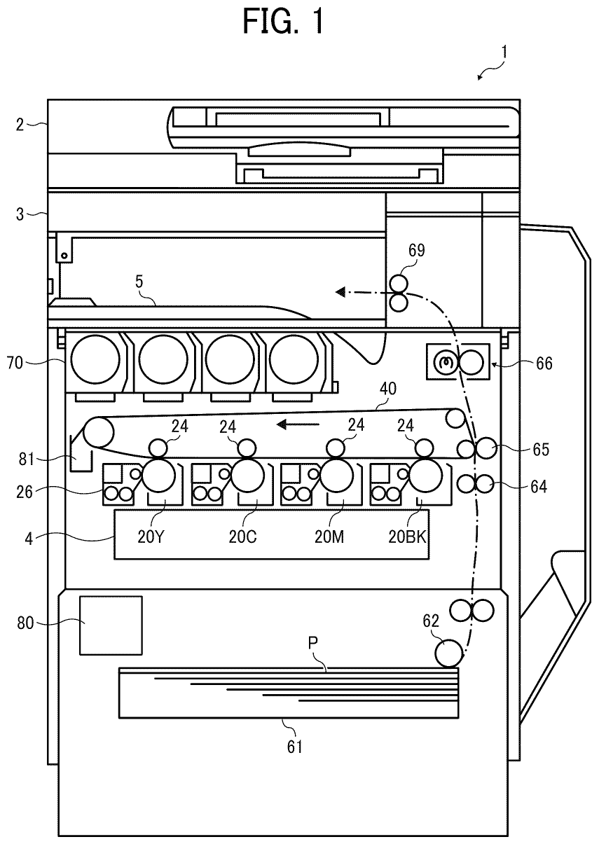

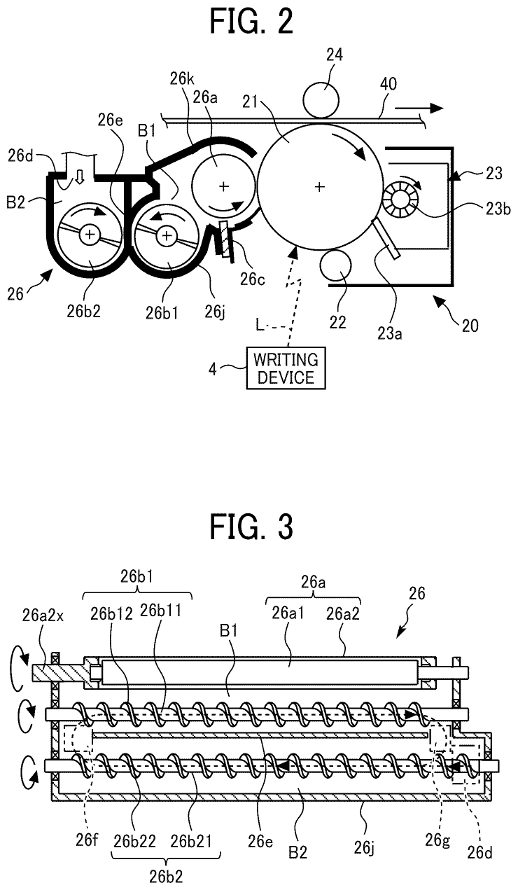

First, with reference to FIG. 1, a description is given of an overall configuration and an operation of an image forming apparatus 1 according to an embodiment of the present disclosure. The image forming apparatus 1 according to the present embodiment is a tandem-type multicolor image forming apparatus in which process cartridges 20Y, 20M, 20C, and 20BK are arranged in parallel to each other, facing an intermediate transfer belt 40. In each of the process cartridges 20Y, 20M, 20C, and 20BK, a developing device 26 (see FIG. 2) is disposed to face a photoconductor drum 21 serving as an image bearer.

In FIG. 1, a body of the image forming apparatus 1, which is illustrated as a color copier in the present embodiment, includes a document conveying device 2, a scanner 3 (document reading device), and a writing device 4 (exposure device). The document conveying device 2 conveys documents to the scanner 3. The scanner 3 scans the documents to read image data. The writing device 4 emits a laser beam based on input image data. Yellow, magenta, cyan, and black toner images are formed on the surfaces of the photoconductor drums 21 of the process cartridges 20Y, 20M, 20C, and 20BK, respectively. The yellow, magenta, cyan, and black toner images on the photoconductor drums 21 are transferred onto the intermediate transfer belt 40 and superimposed. The image forming apparatus 1 further includes a sheet feeder 61, a secondary transfer roller 65, and a fixing device 66. The sheet feeder 61 stores sheets P such as paper sheets. The secondary transfer roller 65 transfers the toner images formed on the intermediate transfer belt 40 onto a sheet P. The fixing device 66 fixes an unfixed toner image on the sheet P. The image forming apparatus 1 still further includes toner containers 70, cleaning devices 23, an intermediate-transfer-belt cleaner 81, and a waste-toner container 80. The toner containers 70 supply toner of the four colors to the respective developing devices 26 of the process cartridges 20Y, 20M, 20C, and 20BK. The waste-toner container 80 collects, as waste toner, untransferred toner collected by the cleaning devices 23 (see FIG. 2) and the intermediate-transfer-belt cleaner 81.

Each of the process cartridges 20Y, 20M, 20C, and 20BK includes the photoconductor drum 21 serving as an image bearer, a charging device 22, and a cleaning device 23, which are united as a single unit as illustrated in FIG. 2. Each of the process cartridges 20Y, 20M, 20C, and 20BK, which is expendable, is removed from a body of the image forming apparatus 1 and replaced with a new one when depleted in the body of the image forming apparatus 1. The developing device 26 is disposed to face the photoconductor drum 21 in each of the process cartridges 20Y, 20M, 20C, and 20BK. Each of the developing devices 26, which is expendable, is removed from the body of the image forming apparatus 1 and replaced with a new one when depleted in the body of the image forming apparatus 1. The attachment and detachment operations of the developing device 26 with respect to the body of the image forming apparatus 1 and the attachment and detachment operations of the process cartridges 20Y, 20M, 20C, and 20BK with respect to the body of the image forming apparatus 1 can be independently performed as different operations. In the process cartridges 20Y, 20M, 20C, and 20BK, the yellow, magenta, cyan, and black toner images are formed on the respective photoconductor drums 21 as the image bearers.

A description is given below of operations of the image forming apparatus 1 to form a normal color toner image. A conveying roller of the document conveying device 2 conveys a document from a document table onto an exposure glass of the document reading device 3. The document reading device 3 optically scans image data for the document on the exposure glass. The yellow, magenta, cyan, and black image data are transmitted to the writing device 4. The writing device 4 irradiates the surface of the photoconductor drums 21 (see FIG. 2) of the process cartridges 20Y, 20M, 20C, and 20BK with laser beams L (as exposure light) according to the yellow, magenta, cyan, and black image data, respectively.

Meanwhile, the four photoconductor drums 21 rotate clockwise as illustrated in FIGS. 1 and 2. The surface of the photoconductor drum 21 is uniformly charged at the position opposite the charging device 22 (a charging roller) (charging process). Thus, the surface of the photoconductor drum 21 is charged to a charging potential. When the charged surface of the photoconductor drum 21 reaches the position to receive the laser beam L emitted from the writing device 4, an electrostatic latent image is formed on the surface of the photoconductor drum 21 according to the image data (exposure process).

The laser beam L corresponding to the yellow image data is emitted to the surface of the photoconductor drum 21 in the process cartridge 20Y, which is the first from the left in FIG. 1 among the four process cartridges 20Y, 20M, 20C, and 20BK. A polygon mirror that rotates at high velocity directs the laser beam L for the yellow image data to the surface of the photoconductor drum 21 along a rotation axis direction of the photoconductor drum 21 (i.e., the main scanning direction). Thus, an electrostatic latent image corresponding to the yellow image data is formed on the photoconductor drum 21 charged by the charging device 22. Similarly, the laser beam L corresponding to the cyan image data is emitted to the surface of the photoconductor drum 21 in the second process cartridge 20C from the left in FIG. 1, thus forming an electrostatic latent image corresponding to the cyan image data on the surface of the photoconductor drum 21. The laser beam L corresponding to the magenta image data is emitted to the surface of the photoconductor drum 21 in the third process cartridge 20M from the left in FIG. 1, thus forming an electrostatic latent image corresponding to the magenta image data on the surface of the photoconductor drum 21. The laser beam L corresponding to the black image data is emitted to the surface of the photoconductor drum 21 in the fourth process cartridge 20BK from the left in FIG. 1, thus forming an electrostatic latent image corresponding to the black image data on the surface of the photoconductor drum 21.

Then, the surface of the photoconductor drum 21 bearing the electrostatic latent image for each color reaches the position opposite the developing device 26. The developing device 26 supplies toner onto the surface of the photoconductor drum 21 and develops the electrostatic latent image on the photoconductor drum 21 into a toner image (development process). After the development process, the surface of the photoconductor drum 21 reaches the position opposite the intermediate transfer belt 40. Primary transfer rollers 24 are disposed at the positions where the surfaces of the corresponding photoconductor drums 21 face the intermediate transfer belt 40 such that the primary transfer rollers 24 contact an inner circumferential surface of the intermediate transfer belt 40. At the positions of the primary transfer rollers 24, the toner images on the photoconductor drums 21 are sequentially transferred to and superimposed on the intermediate transfer belt 40, forming a multicolor toner image thereon (primary transfer process).

After the primary transfer process, the surface of the photoconductor drum 21 reaches a position opposite the cleaning device 23. The cleaning device 23 collects untransferred toner remaining on the photoconductor drum 21 (cleaning process). The untransferred toner collected in the cleaning device 23 passes through a waste-toner conveyance passage and is collected as waste toner in the waste-toner container 80. Then, a charge elimination device discharges a residual potential of the surface of the photoconductor drum 21 at the position opposite the charge elimination device. Thus, a series of image forming processes performed on the photoconductor drum 21 is completed.

Meanwhile, the surface of the intermediate transfer belt 40, onto which the single-color toner images on the photoconductor drums 21 are transferred and superimposed, moves in a direction indicated by an arrow in FIG. 1 and reaches a position opposite a secondary transfer roller 65. The secondary transfer roller 65 secondarily transfers the multicolor toner image on the intermediate transfer belt 40 onto the sheet P (secondary transfer process). After the secondary transfer process, the surface of the intermediate transfer belt 40 reaches the position opposite an intermediate-transfer-belt cleaner 81. The intermediate-transfer-belt cleaner 81 collects the untransferred toner on the intermediate transfer belt 40 to complete a series of transfer processes on the intermediate transfer belt 40. The untransferred toner collected in the intermediate-transfer-belt cleaner 81 passes through a waste-toner conveyance passage and is collected as waste toner in the waste-toner container 80.

The sheet P is conveyed from the sheet feeder 61 to the position of the secondary transfer roller 65 via, for example, a registration roller pair 64. Specifically, a feed roller 62 feeds the sheet P from the top of multiple sheets P stored in the sheet feeder 61. The sheet P is conveyed to the registration roller pair 64 through a sheet conveyance passage. The sheet P that has reached the registration roller pair 64 is conveyed toward the position of the secondary transfer roller 65 so that the sheet P timely meets the arrival of the multicolor toner image on the intermediate transfer belt 40.

Subsequently, the sheet P, onto which the multicolor image is transferred, is conveyed to a fixing device 66. The fixing device 66 includes a fixing roller and a pressure roller pressing against each other. In a nip between the fixing roller and the pressure roller, the multicolor toner image is fixed on the sheet P. After the fixing process, an output roller pair 69 ejects the sheet P as an output image outside the body of the image forming apparatus 1. The ejected sheets P are stacked on an output tray 5. Thus, a series of image forming processes (printing) is completed.

With reference to FIGS. 2 and 3, a description is given in detail below of image forming devices of the image forming apparatus. The four image forming devices disposed in the body of the image forming apparatus 1 (see FIG. 1) have a similar configuration except the colors of the toner used in the image forming processes. Thus, parts of the image forming device such as the process cartridge and the developing device are illustrated without suffixes Y, M, C, and BK, which denote the colors of the toner, in the drawings.

As illustrated in FIG. 2, the process cartridge 20 typically includes the photoconductor drum 21 as the image bearer, the charging device 22, and the cleaning device 23, which are stored in a case of the process cartridge 20 as a single unit. The photoconductor drum 21 is an organic photoconductor designed to be charged with a negative polarity and includes a photosensitive layer formed on a drum-shaped conductive support. The charging device 22 is a charging roller including a conductive core and an elastic layer of moderate resistivity overlaid on the outer circumference of the conductive core. A power supply applies a specified voltage to the charging device 22 (charging roller). Thus, the charging device 22 uniformly charges the surface of the photoconductor drum 21 facing the charging device 22. The cleaning device 23 includes a cleaning blade 25a and a cleaning roller 25b that contact the photoconductor drum 21. For example, the cleaning blade 25a is made of rubber, such as urethane rubber, and contacts the surface of the photoconductor drum 21 at a specified angle with a specified pressure. The cleaning roller 25b is a brush roller in which brush bristles are provided around a core.

As illustrated in FIGS. 2 and 3, the developing device 26 typically includes a developing roller 26a as a developer bearer, a first conveying screw 26b1 (conveying screw) as a developer supply rotator facing the developing roller 26a, a partition 26e, a second conveying screw 26b2 facing the first conveying screw 26b1 via the partition 26e, and a doctor blade 26c as a developer regulator facing the developing roller 26a below to regulate the amount of developer borne on a surface of the developing roller 26a.

The developing device 26 stores developer (two-component developer containing additives) including carrier and toner. In the present embodiment, the average particle diameter of the toner is set to about 5.2 μm, and the average particle diameter of the carrier is set to about 35 μm. In addition, the toner concentration is set to about 7 weight percent (wt %), and the amount of the developer in the developing device 26 is set to about 250 g.

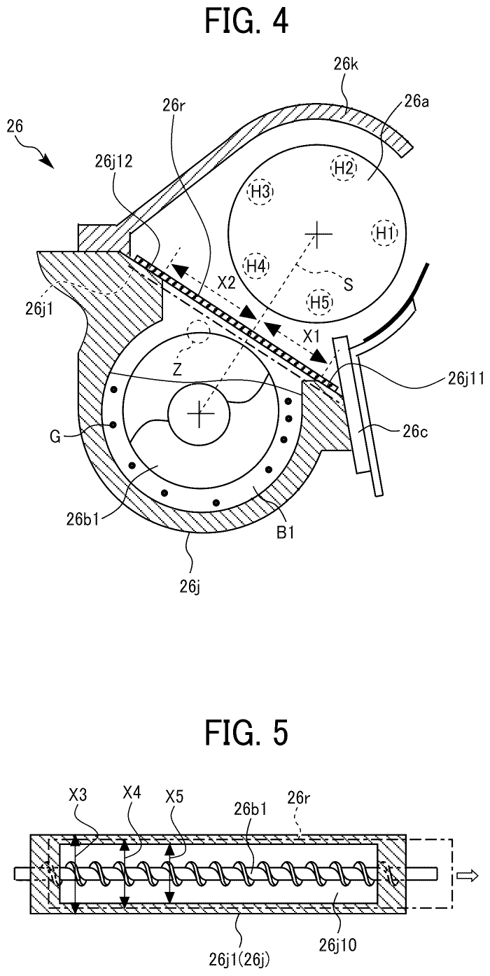

The developing roller 26a faces the photoconductor drum 21 with a small gap (development gap), thereby forming a developing area. As illustrated in FIG. 3, the developing roller 26a includes a magnet 26al secured inside and a sleeve 26a2 that rotates around the magnet 26al. The magnet 26al generates multiple magnetic poles H1 to H5 (see FIG. 4) around an outer circumferential surface of the developing roller 26a.

Specifically, with reference to FIG. 4, a scooping magnetic pole H5 (that is located at a position facing the doctor blade 26c or a position adjacent to above-described position) acts on the carrier as magnetic materials, and developer G contained in a first conveyance passage B1 (see FIG. 2) is scooped up onto the developing roller 26a. A part of the developer G borne on the developing roller 26a is scraped off at the position of the doctor blade 26c (see FIG. 2) and returned to the first conveyance passage B1. On the other hand, the developer G that has passed through a doctor gap between the doctor blade 26c and the developing roller 26a at the position of the doctor blade 26c where the magnetic force by the scooping magnetic pole H5 acts and has been borne on the developing roller 26a stands at the position of a main magnetic pole H1 of the multiple magnetic poles, forms a magnetic brush in the developing area, and slidingly contacts the photoconductor drum 21. Thus, the toner in the developer G borne on the developing roller 26a adheres to the latent image formed on the photoconductor drum 21. Thereafter, the developer G that has passed through the position of the main magnetic pole H1 is conveyed by a plurality of conveying magnetic poles H2 and H3 between the main magnetic pole H1 and an upper developing case 26k, and then is conveyed to the position of the developer releasing magnetic pole H4. A repulsive magnetic field (the magnetic field that acts in a direction away from the developing roller 26a) acts on the carrier at the position of the developer releasing magnetic pole H4, and the developer G borne on the developing roller 26a after the development process is removed from the developing roller 26a. The removed developer G drops into the first conveyance passage B1 and is conveyed downstream from the first conveyance passage B1 by the first conveying screw 26b1 (see FIGS. 2 and 3).

The first conveying screw 26b1 and the second conveying screw 26b2 convey the developer stored in the developing device 26 in a longitudinal direction (in a rotation axis direction) of the developing device 26, thereby establishing a circulation passage indicated by the dashed arrow in FIG. 3. In other words, the circulation path of the developer includes a first conveyance path B1 with the first conveying screw 26b1 and a second conveyance path B2 with the second conveying screw 26b2. The partition 26e is an inner wall and separates the first conveyance passage B1 from the second conveyance passage B2. The first conveyance passage B1 and the second conveyance passage B2 communicate with each other via a first communication opening 26f and a second communication opening 26g disposed at both longitudinal ends of the first conveyance passage B1 and the second conveyance passage B2. Specifically, with reference to FIG. 3, in a conveyance direction of the developer, an upstream end of the first conveyance passage B1 communicates with a downstream end of the second conveyance passage B2 via the first communication opening 26f. On the other hand, in the conveyance direction of the developer, a downstream end of the first conveyance passage B1 communicates with an upstream end of the second conveyance passage B2 via the second communication opening 26g. In other words, the partition 26e is disposed along the circulation passage except both longitudinal ends of the circulation passage.

The first conveying screw 26b1 (or the first conveyance passage B1) is disposed obliquely below the developing roller 26a to face the developing roller 26a. The second conveying screw 26b2 (or the second conveyance passage B2) is disposed opposite the first conveying screw 26b1 (or the first conveyance passage B1) via the partition 26e (inner wall). The first conveying screw 26b1 supplies developer toward the developing roller 26a and collects the developer separated from the developing roller 26a after the development process while conveying the developer in the rotation axis direction (in the longitudinal direction) of the developing device 26. The second conveying screw 26b2 stirs and mixes the developer after the development process conveyed from the first conveyance passage B1 with fresh toner supplied from a toner supply inlet 26d while conveying the developer and the fresh toner in the longitudinal direction of the developing device 26. In the present embodiment, the two conveying screws (i.e., the first conveying screw 26b1 and the second conveying screw 26b2) are horizontally arranged in parallel. The two conveying screws (i.e., the first conveying screw 26b1 and the second conveying screw 26b2) includes rotation shafts (i.e., a rotation shaft 26b11 and a rotation shaft 26b21) and screw portions (i.e., a screw portion 26b12 and a screw portion 26b22) wound around the rotation shafts, respectively. The two conveying screws are driven to rotate at about 600 revolutions per minute (rpm).

With reference to FIG. 2, in the present embodiment, the developing device 26 includes an upper developing case 26k and a lower developing case 26j as developing cases (housings) of the developing device 26. The lower developing case 26j as a developing case is a casing serving as a base of the developing device 26, rotatably holds the developing roller 26a, the first conveying screw 26b1, and the second conveying screw 26b2, and holds the doctor blade 26c. On the other hand, the upper developing case 26k is disposed above the lower developing case 26j (developing roller 26a). In particular, the upper developing case 26k is disposed to cover the lower developing case 26j (developing roller 26a). The upper developing case 26k is detachably attached to the lower developing case 26j holding the developing roller 26a, the first conveying screw 26b1, the second conveying screw 26b2, and the doctor blade 26c by snap-on pins or screws.

A description is further given below of the image forming processes described above, focusing on the development process. The developing roller 26a rotates in a specified direction that is counterclockwise indicated by an arrow in FIG. 2. As illustrated in FIGS. 2 and 3, the first conveying screw 26b1 and the second conveying screw 26b2 are disposed with the partition 26e interposed therebetween and rotate in directions indicated by arrows in FIGS. 2 and 3. Toner is supplied from the toner container 70 to the toner supply inlet 26d through a toner supply passage. As the first conveying screw 26b1 and the second conveying screw 26b2 rotate in the respective directions in FIG. 2, the developer stored in the developing device 26 circulates together with the supplied toner in the longitudinal direction of the developing device 26 (the direction indicated by the dashed arrow in FIG. 3) while being stirred and mixed with the supplied toner. The toner is charged by friction with carrier in the developer and electrostatically attracted to carrier. Then, the toner is scooped up on the developing roller 26a together with carrier by the developer scooping pole H5 generated on the developing roller 26a. The developer borne on the developing roller 26a is conveyed in the counterclockwise direction indicated by the arrow in FIG. 2 to the position opposite the doctor blade 26c. The round-bar doctor blade 26c adjusts the amount of the developer on the developing roller 26a to a proper amount at the position. Subsequently, the rotation of the sleeve 26a2 of the developing roller 26a conveys the developer to the developing area in which the developing roller 26a faces the photoconductor drum 21. Then, the toner in the developer G is attracted to the electrostatic latent image formed on the photoconductor drum 21 due to the effect of an electric field generated in the developing area. As the sleeve 26a2 rotates, the developer remaining on the developing roller 26a reaches above the first conveyance passage B1 and is separated from the developing roller 26a. The electric field in the developing area is generated by a specified voltage (in other words, a development bias) applied to the developing roller 26a by a development power supply and a surface potential (in other words, a latent image potential) formed on the surface of the photoconductor drum 21 in the charging process and the exposure process.

The toner in the toner container 70 is supplied as appropriate through the toner supply passage to the developing device 26 via the toner supply inlet 26d as the toner in the developing device 26 is consumed. The toner consumption in the developing device 26 is detected by a toner concentration sensor that magnetically detects a toner concentration in the developer (i.e., a ratio of toner to the developer) in the developing device 26. The toner supply inlet 26d is disposed above an end of the second conveying screw 26b2 (or the second conveyance passage B2) in a longitudinal direction of the second conveying screw 26b2 (left-and-right direction in FIG. 3).

The configuration and operation of the developing device 26 (image forming apparatus 1) according to the present embodiment are described in detail below. The developing device 26 in the present embodiment is installed to be attachable to and detachable from (i.e. replaceable in) the body of the image forming apparatus 1 and is replaced with a new one (including a recycled one) in a specified replacement cycle. As described above with reference to FIG. 2, in the developing device 26, the developing roller 26a, the first conveying screw 26b1 as a developer supply rotator, and the second conveying screw 26b2 are rotatably disposed in the lower developing case 26j (developing case). In the developing device 26, the doctor blade 26c serving as a developer regulator is disposed on the lower developing case 26j to face the developing roller 26a, which is disposed obliquely above the first conveying screw 26b1 (developer supply rotator), from below and regulates the amount of the developer G borne on the surface of the developing roller 26a.

With reference to FIG. 4, the developing device 26 of the present embodiment includes a sheet-shaped member 26r (which is detachably attached to the developing device 26) to separate the developing roller 26a and the first conveying screw 26b1 (developer supply rotator) to two parts to form a developer pre-storage portion (substantially closed space) in which the developer G is stored inside the part including the first conveying screw 26b1 (the first conveyance passage B1 and the second conveyance passage B2) of the developing device 26 so that the developer G stored in the developing device 26 (the developer G packed in advance at the time of shipment from a factory) does not leak to the outside of developing device 26 by the time when the developer G is started to be used in the body of the image forming apparatus 1.

Specifically, the sheet-shaped member 26r is made of a transparent plastic material such as an overhead projector (OHP) transparency sheet or a MYLAR sheet having a thickness of approximately 0.1 to 0.5 mm and has a substantially rectangular shape to extend in the rotation axis direction (the rotation axis direction of the developing roller 26a, the first conveying screw 26b1, and the second conveying screw 26b2, that is, the left-and-right direction in FIG. 5). The sheet-shaped member 26r is adhered (bonded) to a base 26j1 by a double-sided tape, thermal fusion bonding, to cover an opening 26j10 (see FIG. 5) formed in the base 26j1 of the lower developing case 26j for communicating the space in which the developing roller 26a is disposed and the space in which the first conveying screw 26b1 is disposed (the first conveying passage B1). A new developing device 26 (including a recycled product) is shipped from a factory in a state where the sheet-shaped member 26r is disposed as illustrated in FIGS. 4 and 5. That is, after the developer G is filled into the inside (the first conveyance passage B1 and the second conveyance passage B2) of the developing device 26 in a state where the assembly of the sheet-shaped member 26r to the lower developing case 26j is completed, the sheet-shaped member 26r is adhered to seal the first conveyance passage B1 and the second conveyance passage B2 so that the developer G does not leak to the outside of the developing device 26. Finally, the upper developing case 26k is installed to cover the lower developing case 26j in a state where the sheet-shaped member 26r is set. The developing device 26 for shipment in which the developer G is preset is completed. With reference to FIG. 5, one end of the sheet-shaped member 26r set in the developing device 26 in the longitudinal direction (the direction perpendicular to the plane on which FIG. 4 is illustrated and the left-and-right direction in FIG. 5) protrudes to the outside of the developing device 26 from a clearance between the upper developing case 26k and the lower developing case 26j. In the clearance, a seal member made of an elastic material and having a slit is disposed. A user grips the protruding portion and pulls the protruding portion out in the direction of the white arrow in FIG. 5, so that the opening 26j10 of the base 26j1 is opened and the developing device 26 is ready for use.

As illustrated in FIG. 4, the developing device 26 having such a configuration is attached to the body of the image forming apparatus 1 in a state in which the developer G contained inside the developing device 26 is enclosed and sealed by the sheet-shaped member 26r. Such cases are as follows: (a) the case where the image forming apparatus 1 as a new one in which the developing device 26 as a new one has been installed is shipped, and (b) the case where the developing device 26 as a new one for replacement is installed in the body of the image forming apparatus 1 already used by a user. In any of the above-described cases, before the use (development process) of the developing device 26 as a new one in the body of the image forming apparatus 1 is started, the sheet-shaped member 26r in the enclosed and sealed state is pulled out from the developing device 26. Then, a normal image forming process (development process) is performed in the state as illustrated in FIG. 2.

As described above, in the present embodiment, even when the developing device 26 alone is transported (carried) as a replacement device or when the developing device 26 is transported in a state of being attached on the body of the image forming apparatus 1 at the time of shipment, the developer G stored in the developing device 26 in advance is sealed by the sheet-shaped member 26r. As a result, a failure that the developer G stored in the developing device 26 leaks to the outside of the developing device 26 due to, for example, vibration generated during transportation can be prevented.

In particular, in the present embodiment, as illustrated in FIG. 4, the sheet-shaped member 26r is disposed to separate the developing roller 26a and the first conveying screw 26b1 in the developing device 26 to form the developer pre-storage portion (substantially closed space). With such a configuration, the developer G is not borne on the developing roller 26a during transportation. Thus, a failure that a user touches the surface of the developing roller 26a to get dirty with the developer G can be reliably prevented. Even when the developing device 26 as a new one is installed in the body of the image forming apparatus 1 as a new one to ship the image forming apparatus 1 from a factory, such a configuration can prevent a failure that the surface of the photoconductor drum is damaged by the developer G borne on the surface of the developing roller 26a during transportation.

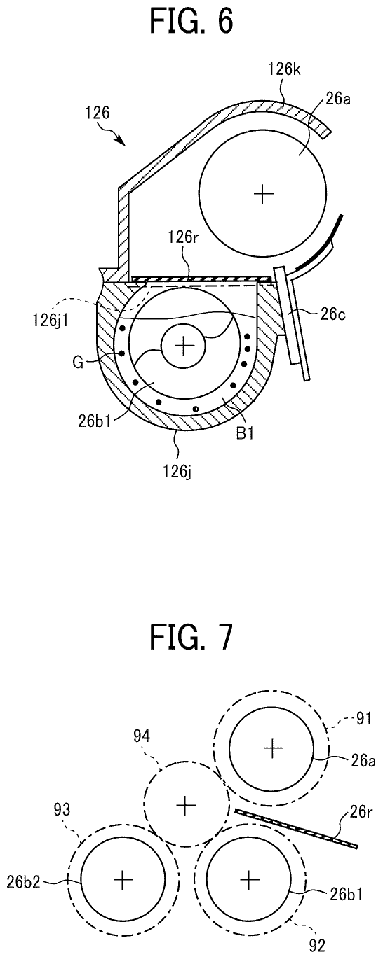

As illustrated in FIG. 4, in the developing device 26 according to the present embodiment, the sheet-shaped member 26r is disposed such that the sheet-shaped member 26r intersects with a virtual line S connecting the rotation center of the developing roller 26a and the rotation center of the first conveying screw 26b1 at 90±10 degrees when viewed in a cross section orthogonal to a rotation shaft 26a2x (see FIG. 3) of the developing roller 26a (or the rotation shaft 26b11 (see FIG. 3) of the first conveying screw 26b1 (the developer supply rotator)). In other words, the sheet-shaped member 26r is disposed to be orthogonal to the virtual line S when viewed in the cross section orthogonal to the rotation shaft 26a2x described above. The term “orthogonal” includes not only a case of being completely orthogonal but also a case of being substantially orthogonal. The “cross section orthogonal to the rotation shaft” is defined as the same meaning as the “cross section orthogonal to the rotation axis direction or the rotation axis”. In other words, unlike a developing device 126 illustrated in FIG. 6 as a comparative example in which a sheet-shaped member 126r is horizontally disposed, the developing device 26 in the present embodiment is provided with the sheet-shaped member 26r that is obliquely disposed to be orthogonal to the virtual line S between the developing roller 26a and the first conveying screw 26b1 in accordance with the first conveying screw 26b1 being disposed obliquely below the developing roller 26a.

With such a configuration, even when the developing roller 26a and the first conveying screw 26b1 (developer supply rotator) face with each other at a short distance, the sheet-shaped member 26r can be disposed to separate the developing roller 26a and the first conveying screw 26b1. Accordingly, the developing device 26 can be reduced in size and weight, and the amount of the developer G for preset can be reduced. Specifically, in order to reduce the size and weight of the developing device 26, it is preferable that the developer G in the first conveyance passage B1 is sufficiently scooped up onto the developing roller 26a even with a small amount of the developer G. For this purpose, it is preferable that the developing roller 26a and the first conveying screw 26b1 face with each other at a short distance. As in the developing device 126 as a comparative example illustrated in FIG. 6, when the sheet-shaped member 126r and a base 126j1 of a lower developing case 126j are horizontally disposed so that the sheet-shaped member 126r does not interfere with the first conveying screw 26b1, there is a limit in shortening the facing distance between the developing roller 26a and the first conveying screw 26b1. As a result, the developing device 26 is increased in size and weight, and further, the amount of the developer G for preset may not be reduced. On the other hand, in the present embodiment, the sheet-shaped member 26r is disposed to be orthogonal to the virtual line S connecting the rotation center of the developing roller 26a and the rotation center of the first conveying screw 26b1, and the space between the developing roller 26a and the first conveying screw 26b1 is efficiently separated. As a result, the facing distance between the developing roller 26a and the first conveying screw 26b1 is set to be short so that the developing device 26 can be reduced in size and weight, and the amount of the developer G for preset can be reduced.

With reference to FIG. 4, the developing device 26 according to the present embodiment is formed such that the facing distance between the developing roller 26a and the sheet-shaped member 26r is longer than the facing distance between the first conveying screw 26b1 (developer supply rotator) and the sheet-shaped member 26r when viewed in a cross section orthogonal to the rotation axis direction (the direction along the rotation shafts 26a2x and 26b11). In other words, the sheet-shaped member 26r is not disposed at an intermediate position (a position at equal intervals) between the developing roller 26a and the first conveying screw 26b1, but is disposed at a position closer to the first conveying screw 26b1. With such a configuration, the preset developer G is less likely to be attracted to the developing roller 26a by the magnetic force. As a result, a failure that the sheet-shaped member 26r is pressed by the developer G attracted in this way and is peeled off from the base 26j1 is less likely to occur.

The sheet-shaped member 26r is removably disposed at a position where the sheet-shaped member 26r does not contact the developing roller 26a even when the sheet-shaped member 26r is moved toward the developing roller 26a by an external force (e.g., the pressure of the developer G stored in the developer pre-storage portion). In other words, the sheet-shaped member 26r is disposed at a distance at which the sheet-shaped member 26r does not contact the developing roller 26a even when the sheet-shaped member 26r is moved toward the developing roller 26a. With such a configuration, a failure that the developing roller 26a is damaged by the contact with the sheet-shaped member 26r can be reduced.

With reference to FIG. 4, the developing device 26 in the present embodiment is formed such that, when viewed in a cross section orthogonal to the rotation axis direction (the direction along the rotation shafts 26a2x and 26b11), both ends of the sheet-shaped member 26r are removably adhered. A distance X1 between an intersection point of the sheet-shaped member 26r and the virtual line S and a downstream sheet sticking position 26j11 corresponding to a downstream side of in the rotation direction of the developing roller 26a is shorter than a distance X2 between the intersection point and an upstream sheet sticking position 26j12 corresponding to an upstream side of in the rotation direction of the developing roller 26a (X1<X2).

Specifically, as described above, the lower developing case 26j (developing case) in the present embodiment rotatably holds the developing roller 26a and the first conveying screw 26b1 (developer supply rotator). The lower developing case 26j to which the sheet-shaped member 26r is removably adhered is formed with the base 26j1 having the opening 26j10 (see FIG. 5) sealed by the sheet-shaped member 26r. The downstream sheet sticking position 26j11 and the upstream sheet sticking position 26j12 are formed in the base 26j1. With reference to FIG. 4, the developing device 26 in the present embodiment is formed such that, when viewed in a cross section orthogonal to the rotation axis direction (the direction along the rotation shafts 26a2x and 26b11), the distance X1 between the intersection point of the sheet-shaped member 26r and the virtual line S and the downstream sheet sticking position 26j11 (corresponding to the downstream side of the base 26j1 in the rotation direction of the developing roller 26a, that is, the right sticking portion in FIG. 4) is shorter than the distance X2 between the intersection point and the upstream sheet sticking position 26j12 (corresponding to the upstream side of the base 26j1 in the rotation direction of the developing roller 26a, that is, the left sticking portion in FIG. 4) (X1<X2). This is because, when the upstream sheet sticking position 26j12 is close to the developing roller 26a, the movement of the developer G separated toward the first conveyance passage B1 at the position of the developer releasing magnetic pole H4 in the developing roller 26a is likely to be easily blocked by the upstream sheet sticking position 26j12 during the development process. When such deterioration of the developer separation of the developer G occurs, an abnormal image may occur. In the present embodiment, the upstream sheet sticking position 26j12 is disposed at a position sufficiently away from the developing roller 26a, so that such a failure is less likely to occur.

As illustrated in FIG. 4, in the present embodiment, the doctor blade 26c (developer regulator) is disposed obliquely above the developing roller 26a with respect to the first conveying screw 26b1 to face the developing roller 26a from below. The base 26j1 is formed such that the downstream sheet sticking position 26j11 is located at a position lower than a top Z of the first conveying screw 26b1 (developer supply rotator), and the upstream sheet sticking position 26j12 is located at a position higher than the top Z. With such a configuration, the sheet-shaped member 26r can be easily disposed to be orthogonal to the virtual line S connecting the rotation center of the developing roller 26a and the rotation center of the first conveying screw 26b1.

As illustrated in FIG. 4, in the present embodiment, the doctor blade 26c (developer regulator) is set so that the position of the tip (upper end) facing the developing roller 26a is higher than the downstream sheet sticking position 26j11 and lower than the upstream sheet sticking position 26j12. With such a configuration, the sheet-shaped member 26r can be easily disposed to be orthogonal to the virtual line S connecting the rotation center of the developing roller 26a and the rotation center of the first conveying screw 26b1 while maintaining the function of the doctor blade 26c in a preferable manner.

As illustrated in FIG. 5, in the developing device 26 according to the present embodiment, a lateral range X4 of the sheet-shaped member 26r is set to be within a lateral range X3 of the base 26j1 and to include a lateral range X5 of the opening 26j10. In other words, when the lateral width of the outer circumferential portion of the base 26j1 is X3, the lateral width of the opening 26j10 is X5, and the lateral width of the sheet-shaped member 26r is X4, the relation of X3>X4>X5 is established. With such a configuration, the opening 26j10 is reliably sealed by the sheet-shaped member 26r, and the sheet-shaped member 26r can be easily pulled out in the direction indicated by the white arrow in FIG. 5 at the start of use of the developing device 26.

### First Modification

As illustrated in FIG. 7, the developing device 26 according to a first modification includes a first gear 91, a second gear 92, a third gear 93, and an idler gear 94 on one end (drive side) in the longitudinal direction of the developing device 26. The first gear 91 is disposed on the rotation shaft 26a2x (see FIG. 3) of the developing roller 26a. The second gear 92 is disposed on the rotation shaft 26b11 (see FIG. 3) of the first conveying screw 26b1 (developer supply rotator). The third gear 93 is disposed on the rotation shaft 26b21 (see FIG. 3) of the second conveying screw 26b2. The idler gear 94 meshes with the first gear 91, the second gear 92, and the third gear 93. Then, a driving force is transmitted from a drive motor to any one of the first gear 91, the second gear 92, the third gear 93, and the idler gear 94. Thus, each of the developing roller 26a, the first conveying screw 26b1, and the second conveying screw 26b2 is rotated in a specified direction. As illustrated in FIG. 7, in the developing device 26 according to the first modification, when viewed in a cross section orthogonal to the rotation axis direction (the direction along the rotation shafts 26a2x and 26b11), at least a part of the sheet-shaped member 26r is disposed in a space surrounded by the first gear 91, the second gear 92, and the idler gear 94. With such a configuration, even when the sheet-shaped member 26r is pulled out from one end (drive side) of the developing device 26 in the longitudinal direction, the sheet-shaped member 26r is less likely to interfere with the first gear 91, the second gear 92, or the idler gear 94. In particular, in the first modification, an outer diameter of the idler gear 94 (an outer diameter of tooth tip circle) is smaller than an outer diameter of the first gear 91, and smaller than an outer diameter of the second gear 92. Thus, the lateral width of the sheet-shaped member 26r can be relatively wide in the space surrounded by the first gear 91, the second gear 92, and the idler gear 94. The lateral opening width of the opening 26j10 in the base 26j1 can be easily wide.

### Second Modification

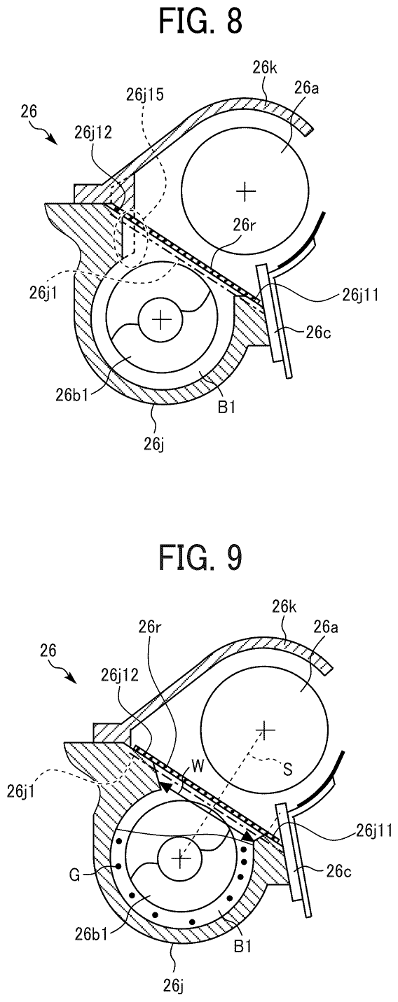

As illustrated in FIG. 8, in the developing device 26 in a second modification, the base 26j1 has a cutout 26j15 (or a recess) that reduces a portion overlapping with the upper developing case 26k at an end in the longitudinal direction (a portion where an end seal for the developing roller 26a is disposed). If the developing device 26 is placed alone in the vertical direction during transportation or storage, the developer G is packed in a state where the developer G is biased to one end in the longitudinal direction, which is positioned at the lower side in the vertical direction. In such a case, when the sheet-shaped member 26r is sandwiched in a large area in the portion where the base 26j1 and the upper developing case 26k overlap, the sheet-shaped member 26r is pushed into the upper developing case 26k by the developer G that has entered between the base 26j1 and the sheet-shaped member 26r. Thus, the operation of pulling out the sheet-shaped member 26r at the time of arrival is difficult. On the other hand, in the second modification, the cutout 26j15 is provided in the portion where the base 26j1 and the upper developing case 26k overlap with each other. The area where the sheet-shaped member 26r is sandwiched in the portion is reduced. Thus, such a failure is less likely to occur.

### Third Modification

As illustrated in FIG. 9, in the developing device 26 according to a third modification, the opening 26j10 in the base 26j1 is formed such that the opening area W orthogonal to the virtual line S gradually decreases from the upper portion toward the lower portion. In particular, in the base 26j1 in the third modification, the inner wall of the opening 26j10 closer to the upstream sheet sticking position 26j12 is formed not to enter the first conveyance passage B1, similarly to the inner wall of the opening 26j10 closer to the downstream sheet sticking position 26j11. In other words, when viewed in a cross section orthogonal to the rotation axis direction (the direction along the rotation shafts 26a2x and 26b11), the inner wall of the opening 26j10 is formed in a wide open-bottom V shape with reference to the virtual line S. With such a configuration, even when the developing device 26 is transported in a state where the developing device 26 is turned upside down from a normal posture, the aggregated developer G for preset is easily broken up when the developing device 26 is returned to the normal posture before the start of use. In the development process, the supply of the developer from the first conveying screw 26b1 to the developing roller 26a is less likely to be hindered by the downstream sheet sticking position 26j11.

### Fourth Modification

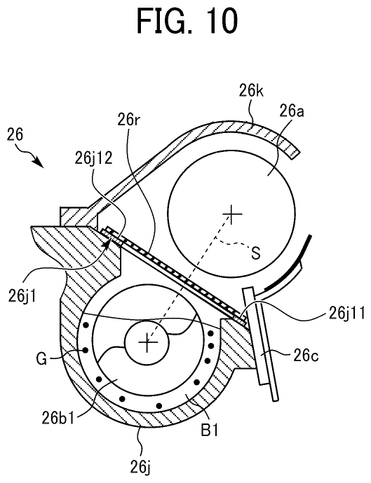

As illustrated in FIG. 10, the developing device 26 in a fourth modification also has the base 26j1 on the lower developing case 26j. In the developing device 26 in the fourth modification, the base 26j1 is not united as a part of the lower developing case 26j, but the base 26j1 is adhered (bonded) as a separate component to the lower developing case 26j via, for example, a double-sided tape or an adhesive. The opening 26j10 is formed in the base 26j1, and the sheet-shaped member 26r is disposed on the base 26j1 to cover the opening 26j10. When the developing device 26 is started to be used, the sheet-shaped member 26r is pulled out from the base 26j1. The base 26j1 functions as a part of the lower developing case 26j even after the developing device 26 is started to be used. The base 26j1 as a separate component is formed on the lower developing case 26j so that the base 26j1 can be formed of a material that is easy to adhere to the sheet-shaped member 26r by heat welding or with a double-sided tape in the case where the lower developing case 26j is formed of a material that is difficult to adhere to the sheet-shaped member 26r by heat welding or with a double-sided tape.

As described above, the developing device 26 according to the present embodiment is detachably installed to the body of the image forming apparatus 1 and contains the developer G. The developing device 26 includes the developing roller 26a and the first conveying screw 26b1. The developing roller 26a bears the developer G and develops a latent image formed on the surface of the photoconductor drum 21 (image bearer). The first conveying screw 26b1 (developer supply rotator) that faces the developing roller 26a rotates in a specified direction to supply the developer G to the developing roller 26a. The sheet-shaped member 26r is removably installed so that the developer G contained in the developing device 26 does not leak to the outside of the developing device 26. The sheet-shaped member 26r separates the developing roller 26a and the first conveying screw 26b1 to form a developer pre-storage portion that contains the developer G in an inner space on the side on which the first conveying screw 26b1 is disposed with the sheet-shaped member 26r in the developing device 26. The sheet-shaped member 26r is disposed to intersect with the virtual line S connecting the rotation center of the developing roller 26a and the rotation center of the first conveying screw 26b1 at 90±10 degrees when viewed in a cross section orthogonal to the rotation shaft of the developing roller 26a or the first conveying screw 26b1. With such a configuration, even if the developing roller 26a and the first conveying screw 26b1 face each other at a short distance, the sheet-shaped member 26r can be disposed to separate the developing roller 26a and the first conveying screw 26b1.

In the present embodiment, the process cartridge 20 does not include the developing device 26. The developing device 26 is a unit that is independently attachable to and detachable from the body of the image forming apparatus 1. Alternatively, the developing device 26 may be one of the constituent elements of the process cartridge 20. In this case, the process cartridge 20 including the developing device 26 as an integral part is attachable to and detachable from the body of the image forming apparatus 1. In such a configuration, similar effects to those of the present embodiment are also attained. The term “process cartridge” used in the present disclosure is defined as a unit that unites an image bearer and at least one of a charging device to charge the image bearer, a developing device to develop a latent image on the image bearer, and a cleaning device to clean the image bearer and that is attachable to and removable from the body of the image forming apparatus.

In the present embodiment, the developing device 26 includes the two conveying screws (i.e., the first conveying screw 26b1 and the second conveying screw 26b2) as the conveyors horizontally arranged in parallel and the doctor blade 26c disposed below the developing roller 26a. The configuration of the developing device is not limited to the above-described configuration. In the developing device according to one or more embodiments of the present disclosure, three or more conveyors may be horizontally arranged in parallel, multiple conveyors may be arranged in parallel in the vertical direction, or the doctor blade may be disposed above the developing roller. In the present embodiment, the developing device 26 includes the conveying screw (the first conveying screw 26b1) in which the screw portion 26b12 is wound around the rotation shaft 26b11 as the developer supply rotator. However, the developer supply rotator is not limited thereto, and the developing device may include a conveying paddle having a plurality of blade portions formed radially in the circumferential direction on the rotation shaft, for example, as the developer supply rotator. Such a case can also provide similar effects to those of the present embodiment.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

Aspects of the present disclosure may be, for example, combinations of first to fifteenth aspects as follows.

### First Aspect

A developing device (e.g., the developing device 26) detachably attached to a body of an image forming apparatus and storing developer includes a developing roller (e.g., the developing roller 26a), a developer supply rotator (e.g., the first conveying screw 26b1), and a sheet-shaped member (e.g., the sheet-shaped member 26r). The developing roller bears the developer and develops a latent image formed on a surface of an image bearer (e.g., the photoconductor drum 21). The developer supply rotator is disposed opposite the developing roller and rotates in a specified direction to supply the developer to the developing roller. The sheet-shaped member is removable, separates the developing roller and the developer supply rotator from each other so that the developer stored in the developing device does not leak to the outside, and forms a developer pre-storage portion storing the developer in an inner space on a side on which the developer supply rotator is disposed in the developing device. The sheet-shaped member is disposed to intersect with a virtual line (e.g., the virtual line S) connecting a rotation center of the developing roller and a rotation center of the developer supply rotator at 90±10 degrees when viewed in a cross section orthogonal to a rotation shaft (e.g., the rotation shaft 26b11) of the developing roller or the developer supply rotator.

### Second Aspect

In the developing device (e.g., the developing device 26) according to the first aspect, a distance between the developing roller (e.g., the developing roller 26a) and the sheet-shaped member (e.g., the sheet-shaped member 26r) is longer than a distance between the developer supply rotator (e.g., the first conveying screw 26b1) and the sheet-shaped member when viewed in the cross section.

### Third Aspect

In the developing device (e.g., the developing device 26) according to the first or second aspect, when viewed in the cross section, both ends of the sheet-shaped member (e.g., the sheet-shaped member 26r) are removably adhered to the developing device. A distance between an intersection point of the sheet-shaped member and the virtual line (e.g., the virtual line S) and a downstream sheet sticking position (e.g., the downstream sheet sticking position 26j11) corresponding to a downstream side in a rotation direction of the developing roller (e.g., the developing roller 26a) is shorter than a distance between the intersection point and an upstream sheet sticking position (e.g., the upstream sheet sticking position 26j12) corresponding to an upstream side in the rotation direction of the developing roller.

### Fourth Aspect

The developing device (e.g., the developing device 26) according to the third aspect further includes a developing case (e.g., the lower developing case 26j, the upper developing case 26k) rotatably holds the developing roller (e.g., the developing roller 26a) and the developer supply rotator (e.g., the first conveying screw 26b1). The developing case includes a base (e.g., the base 26j1) having an opening (e.g., the opening 26j10) sealed with the sheet-shaped member removably adhered to the base. The downstream sheet sticking position (e.g., the downstream sheet sticking position 26j11) and the upstream sheet sticking position (e.g., the upstream sheet sticking position 26j12) are formed in the base.

### Fifth Aspect

In the developing device (e.g., the developing device 26) according to the fourth aspect, a lateral range (e.g., the range X4) of the sheet-shaped member (e.g., the sheet-shaped member 26r) is set to be within a lateral range (e.g., the range X3) of the base (e.g., the base 26j1) and include a lateral range (e.g., the range X5) of the opening (e.g., the opening 26j10).

### Sixth Aspect

In the developing device (e.g., the developing device 26) according to the fourth or fifth aspect, the developing case (e.g., the lower developing case 26j, the upper developing case 26k) includes a lower developing case (e.g., the lower developing case 26j) having the base (e.g., the base 26j1) and an upper developing case (e.g., the upper developing case 26k) disposed above the lower developing case. The base has a cutout (e.g., the cutout 26j15) or a recess that reduces a portion overlapping with the upper developing case at a longitudinal end of the base.

### Seventh Aspect

In the developing device (e.g., the developing device 26) according to any one of the fourth to sixth aspects, the base (e.g., the base 26j1) is formed such that the downstream sheet sticking position (e.g., the downstream sheet sticking position 26j11) is located at a position lower than a top (e.g., the top Z) of the developer supply rotator (e.g., the first conveying screw 26b1) and the upstream sheet sticking position (e.g., the upstream sheet sticking position 26j12) is located at a position higher than the top.

### Eighth Aspect

In the developing device (e.g., the developing device 26) according to any one of the fourth to seventh aspects, the opening (e.g., the opening 26j10) is formed such that an opening area (e.g., the opening area W) orthogonal to the virtual line (e.g., the virtual line S) gradually decreases from an upper portion toward a lower portion.

### Ninth Aspect

The developing device (e.g., the developing device 26) according to any one of the third to eighth aspects further includes a developer regulator (e.g., the doctor blade 26c) that faces the developing roller (e.g., the developing roller 26a) disposed obliquely above the developer supply rotator (e.g., the first conveying screw 26b1) from below and regulates an amount of the developer borne on the surface of the developing roller. A position of a tip of the developer regulator facing the developing roller is higher than the downstream sheet sticking position (e.g., the downstream sheet sticking position 26j11) and lower than the upstream sheet sticking position (e.g., the upstream sheet sticking position 26j12).

### Tenth Aspect

In the developing device (e.g., the developing device 26) according to any one of the first to ninth aspects, the sheet-shaped member (e.g., the sheet-shaped member 26r) is removably disposed at a position at which the sheet-shaped member does not contact the developing roller (e.g., the developing roller 26a) even when the sheet-shaped member is moved toward the developing roller by application of an external force.

### Eleventh Aspect

The developing device (e.g., the developing device 26) according to any one of the first to tenth aspects further includes a first gear (e.g., the first gear 91) disposed on a rotation shaft (e.g., the rotation shaft 26a2x) of the developing roller (e.g., the developing roller 26a), a second gear (e.g., the second gear 92) disposed on a rotation shaft (e.g., the rotation shaft 26b11) of the developer supply rotator (e.g., the first conveying screw 26b1), and an idler gear (e.g., the idler gear 94) that meshes with the first gear and the second gear. At least a part of the sheet-shaped member (e.g., the sheet-shaped member 26r) is disposed in a space surrounded by the first gear, the second gear, and the idler gear when viewed in the cross section.

### Twelfth Aspect

In the developing device (e.g., the developing device 26) according to the eleventh aspect, an outer diameter of the idler gear (e.g., the idler gear 94) is smaller than an outer diameter of the first gear (e.g., the first gear 91) and smaller than an outer diameter of the second gear (e.g., the second gear 92).

### Thirteenth Aspect

In the developing device (e.g., the developing device 26) according to any one of the first to twelfth aspects, the developer supply rotator is a first conveying screw (e.g., the first conveying screw 26b1) including a rotation shaft (e.g., the rotation shaft 26b11) and a screw portion (e.g., the screw portion 26b12) wound around the rotation shaft and conveys the developer in a rotation axis direction. The developing device further includes a second conveying screw (e.g., the second conveying screw 26b2) disposed opposite the first conveying screw via a wall (e.g., the partition 26e) and forms a circulation passage of the developer together with the first conveying screw.

### Fourteenth Aspect

A process cartridge (e.g., the process cartridge 20) removably attached to the body of the image forming apparatus includes the developing device (e.g., the developing device 26) according to any one of the first to thirteenth aspects and the image bearer (e.g., the photoconductor drum 21) united with each other.

### Fifteenth Aspect

An image forming apparatus (e.g., the image forming apparatus 1) includes the developing device (e.g., the developing device 26) according to any one of the first to thirteenth aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A developing device detachably attachable to a body of an image forming apparatus and storing developer, the developing device comprising:
a developing roller to bear the developer and develop a latent image on a surface of an image bearer;
a developer supply rotator disposed opposite the developing roller to rotate in a specified direction to supply the developer to the developing roller; and
a removable sheet-shaped member that separates the developing roller and the developer supply rotator to form a developer pre-storage portion storing the developer in an inner space in which the developer supply rotator is disposed in the developing device,
wherein the sheet-shaped member intersects with a virtual line connecting a rotation center of the developing roller and a rotation center of the developer supply rotator at 90±10 degrees when viewed in a cross section orthogonal to a rotation shaft of the developing roller or the developer supply rotator.

2. The developing device according to claim 1,
wherein a distance between the developing roller and the sheet-shaped member is longer than a distance between the developer supply rotator and the sheet-shaped member when viewed in the cross section.

3. The developing device according to claim 1,
wherein, when viewed in the cross section, both ends of the sheet-shaped member are removably adhered in the developing device, and
wherein a distance between an intersection point of the sheet-shaped member and the virtual line and a downstream sheet sticking position corresponding to a downstream side in a rotation direction of the developing roller is shorter than a distance between the intersection point and an upstream sheet sticking position corresponding to an upstream side in the rotation direction of the developing roller.

4. The developing device according to claim 3, further comprising a developing case rotatably holding the developing roller and the developer supply rotator,
wherein the developing case includes a base having an opening sealed with the sheet-shaped member removably adhered to the base, and
wherein the base includes the downstream sheet sticking position and the upstream sheet sticking position.

5. The developing device according to claim 4,
wherein a lateral range of the sheet-shaped member is within a lateral range of the base and includes a lateral range of the opening.

6. The developing device according to claim 4,
wherein the developing case includes a lower developing case having the base and an upper developing case disposed above the lower developing case, and
wherein the base has a cutout or a recess that reduces a portion overlapping with the upper developing case at a longitudinal end of the base.

7. The developing device according to claim 4,
wherein the downstream sheet sticking position of the base is at a position lower than a top of the developer supply rotator, and the upstream sheet sticking position of the base is at a position higher than the top.

8. The developing device according to claim 4,
wherein an opening area of the opening orthogonal to the virtual line gradually decreases from above to below along the virtual line.

9. The developing device according to claim 3, further comprising a developer regulator facing the developing roller, which is disposed obliquely above the developer supply rotator, from below to regulate an amount of the developer borne on the surface of the developing roller,
wherein a position of a tip of the developer regulator facing the developing roller is higher than the downstream sheet sticking position and lower than the upstream sheet sticking position.

10. The developing device according to claim 1,
wherein the sheet-shaped member is removably disposed at a position at which the sheet-shaped member is away from the developing roller even when the sheet-shaped member is moved toward the developing roller by application of an external force.

11. The developing device according to claim 1, further comprising:
a first gear on a rotation shaft of the developing roller;
a second gear on a rotation shaft of the developer supply rotator; and
an idler gear to mesh with the first gear and the second gear,
wherein at least a part of the sheet-shaped member is disposed in a space surrounded by the first gear, the second gear, and the idler gear when viewed in the cross section.

12. The developing device according to claim 11,
wherein an outer diameter of the idler gear is smaller than an outer diameter of the first gear and smaller than an outer diameter of the second gear.

13. The developing device according to claim 1,
wherein the developer supply rotator is a first conveying screw including a rotation shaft and a screw portion wound around the rotation shaft to convey the developer in a rotation axis direction of the first conveying screw, and
wherein the developing device further comprises a second conveying screw disposed opposite the first conveying screw via a wall to form a circulation passage of the developer together with the first conveying screw.

14. A process cartridge removably attachable to a body of an image forming apparatus, the process cartridge comprising:
the developing device according to claim 1; and
an image bearer united with the developing device.

15. An image forming apparatus comprising the developing device according to claim 1.
